(19) United States
(12) Patent Application Publication
(10) Pub. No.: US 2013/0227425 A1
(43) Pub. Date: Aug. 29, 2013

(54) SITUATION-BASED INFORMATION PROVIDING SYSTEM WITH SERVER AND USER TERMINAL, AND METHOD THEREOF

(71) Applicant: SAMSUNG ELECTRONICS CO., LTD., (US)

(72) Inventors: Sin-ae KIM, Seoul (KR); Young-sun KIM, Suwon-si (KR); Seung-eok CHOI, Suwon-si (KR)

(73) Assignee: SAMSUNG ELECTRONICS CO., LTD., Suwon-si (KR)

(21) Appl. No.: 13/774,346

(22) Filed: Feb. 22, 2013

(30) Foreign Application Priority Data
Feb. 23, 2012 (KR) 10-2012-0018625

(51) Int. Cl. G06F 3/0484

(52) U.S. Cl. CPC G06F 3/04842
USPC 715/740

(57) ABSTRACT

A situation based information providing system including a user interface and a server is provided. The user terminal includes: a display; a communicator configured to communicate with another user terminal located within a predetermined distance or range from the user terminal; and a controller configured to receive terminal identification information from the other user terminal, and to control, in response to the received terminal identification information of the other user terminal, time information, and location information of the user terminal satisfying pre-set conditions, the display to display information related to a situation which corresponds to the pre-set conditions.

### CROSS-REFERENCE TO RELATED APPLICATIONS

This application claims priority from Korean Patent Application No. 10-2012-0018625, filed on Feb. 23, 2012, in the Korean Intellectual Property Office, the disclosure of which is incorporated herein by reference, in its entirety.

### BACKGROUND

1. Field

Apparatuses and methods consistent with exemplary embodiments to a situation-based information providing system, and a method thereof. In particular, the exemplary embodiments relate to a situation-based information providing system, and a situation-based information providing method which provides information based on a user's situation information.

2. Description of the Related Art

With the commercialization of smart devices having convenient user interfaces and high-performance computing capabilities, various kinds of services have been provided through smart devices.

A representative one of the services is a service based on information relating to the location of a user. When a smart device uses a location-based service, the smart device transmits its current location information to a server, receives from the server services related to the current location, and provides the services to a user. For example, in response to a user requesting his or her smart phone to search for restaurants in order to have lunch, the smart phone transmits the user's current location information to a server, receives information regarding restaurants located near the user's current location from the server, and displays the received information on a screen. Then, in response to the user finding an appropriate restaurant based on the displayed information and visiting the restaurant, the smart phone displays on the screen cuisine menus which the restaurant offers as well as price information. As such, a location-based service provides a mobile environment that can overcome the spatial limitations of computers and the Internet.

As smart devices come to receive web services through the Internet, social network services (SNSs) are actively used through smart devices. For example, a user of a smart phone can post on Facebook or Twitter in real time, and view postings from his or her friends. The SNS has a great significance in that it has connected computers and the Internet to the real world as sociocultural spaces by building social relationships on the computers and the Internet.

However, up to now, no mobile service based on both the location information and social relationship of a user of a smart device has been introduced.

### SUMMARY

Exemplary embodiments overcome the above disadvantages and other disadvantages not described above. Also, the exemplary embodiments are not required to overcome the disadvantages described above, and an exemplary embodiment may not overcome any of the problems described above.

The exemplary embodiments propose a new concept of a mobile service, and provide a situation-based information providing system including a server and a user terminal, and a situation-based information providing method for displaying information related to a situation which corresponds to pre-set conditions in response to terminal identification information from another user terminal adjacent to the user terminal, time information, and location information of the user terminal satisfying the pre-set conditions.

A user terminal according to an exemplary embodiment includes a display, a communicator configured to communicate with another user terminal located within a predetermined distance or range from the user terminal, and a controller configured to receive terminal identification information from the other user terminal, and to control, in response to the received terminal identification information of the other user terminal, time information, and location information of the user terminal satisfying pre-set conditions, the display to display information related to a situation which corresponds to the pre-set conditions.

The user terminal may further include an input configured to receive the user's input, wherein the pre-set conditions are set by the user's input.

In response to the terminal identification information of the user terminal, the time information, and the location information of the user terminal satisfying the pre-set conditions, the controller may control the display to display an application related to the situation which corresponds to the pre-set conditions.

The controller may control the display to display the application in consideration of one or more of a keyword input by the user, content being used by the user, and log history.

The controller may control the display to display information related to the situation which corresponds to the pre-set conditions according to a pre-defined relationship between the user of the user terminal and the user of the other user terminal.

The pre-defined relationship may be at least one of a co-worker relationship, a friend relationship, a business relationship and a romantic relationship.

The communicator may transmit the terminal identification information of the user terminal and the terminal identification information of the other user terminal, to the server, and may receive from the server information regarding the pre-defined relationship between the user of the user terminal and the user of the other user terminal.

The server may be at least one of a social network service (SNS) server providing an SNS, a mail server, and a cloud server.

A server according to an exemplary embodiment includes a communicator configured to communicate with a user terminal, a storage configured to store a pre-defined relationship between users of a plurality of user terminals, and a controller configured to read, in response to receiving from the user terminal terminal identification information of another user terminal located within a predetermined distance or range from a user terminal of the plurality of user terminals, information regarding a pre-defined relationship between the user of the user terminal and the user of the other user terminal from the storage, and to control the communicator to transmit the information regarding the pre-defined relationship to the user terminal.

A situation-based information providing system according to an exemplary embodiment includes a server configured to receive from the user terminal terminal identification information of another user terminal located within a predetermined distance or range from a user terminal, and to transmit information regarding a pre-defined relationship between the user of the user terminal and the user of the other user terminal to the user terminal, and the user terminal configured to display information related to a situation according to the information regarding the pre-defined relationship between the user of the user terminal and the user of the other user terminal, time information, and location information of the user terminal.

A situation-based information providing method according to an exemplary embodiment includes receiving, at a user terminal, terminal identification information from another user terminal located within a predetermined distance or range from the user terminal, and displaying, at the user terminal, information related to a situation which corresponds to pre-set conditions in response to the terminal identification information of the other user terminal, time information, and location information of the user terminal satisfy the pre-set conditions.

The pre-set conditions may be set by the user's input.

The displaying of the information related to the situation which corresponds to the pre-set conditions may include displaying an application related to the situation which corresponds to the pre-set conditions in response to the terminal identification information of the other user terminal, the time information, and the location information of the user terminal satisfying the pre-set conditions.

The displaying of the information related to the situation which corresponds to the pre-set conditions may include displaying the application in consideration of one or more of a keyword input by the user content being used by the user, and log history.

The displaying of the information related to the situation which corresponds to the pre-set conditions may include displaying information related to the situation which corresponds to the pre-set conditions according to a pre-defined relationship between the user of the user terminal and the user of the other user terminal.

The pre-defined relationship may be at least one of a co-worker relationship, a friend relationship, a business relationship, and a romantic relationship.

The displaying of the information related to the situation which corresponds to the pre-set conditions may include transmitting to the server the terminal identification information of the user terminal and the terminal identification information of the other user terminal and receiving from the server information regarding a pre-defined relationship between the user of the user terminal and the user of the other user terminal and displaying the information related to the situation which corresponds to the pre-set conditions according to the pre-defined relationship between the user of the user terminal and the user of the other user terminal.

The server may be at least one of a social network service (SNS) server providing an SNS, a mail server and a cloud server.

A situation-based information providing method according to an exemplary embodiment includes receiving, at a server, terminal identification information of another user terminal located within a predetermined distance or range from a user terminal and transmitting, at the server, information regarding a pre-defined relationship between the user of the user terminal and the user of the other user terminal, to the user terminal.

A situation-based information providing method according to an exemplary embodiment includes receiving, at a user terminal, terminal identification information of another user terminal located within a predetermined distance or range from the user terminal, transmitting, at the user terminal, terminal identification information of the user terminal and terminal identification information of the other user terminal to a server, transmitting, at the server, information regarding a pre-defined relationship between the user of the user terminal and the user of the other user terminal to the user terminal, and displaying, at the user terminal, information related to a situation which corresponds to pre-set conditions according to the information regarding the pre-defined relationship between the user of the user terminal and the user of the other user terminal in response to the terminal identification information of the other user terminal, time information and location information of the user terminal satisfy the pre-set conditions.

As described above, by identifying another user adjacent to a user possessing a user terminal, information related to the user's situation is provided according to a social relationship with the other user and the user's location information.

An exemplary embodiment may include a situation-based information providing system based on both the location information and social relationship of a user of a smart device, the system providing: a server configured to receive from a user terminal identification information of another user terminal located within a predetermined distance or range from a user terminal, and to transmit to the user terminal information regarding a pre-defined relationship between the user of the user terminal and the user of the other user terminal; and the user terminal being configured to display information related to a situation according to the information regarding the pre-defined relationship between the user of the user terminal and the user of the other user terminal, time information and location information of the user terminal, wherein the pre-defined relationship includes a social relationship.

The system may further include an input configured to receive a user's input, wherein the pre-set conditions are set by the user's input.

Additional and/or other aspects and advantages of the exemplary embodiments will be set forth in part in the description which follows and, in part, will be obvious from the description, or may be learned by practice of the exemplary embodiments.

### BRIEF DESCRIPTION OF THE DRAWING FIGURES

The above and/or other aspects of the present invention will be more apparent by describing certain exemplary embodiments with reference to the accompanying drawings, in which:

FIG. 1 is a block diagram showing the configuration of a user terminal according to an exemplary embodiment;

FIG. 2 shows an example in which the user terminal of FIG. 1 displays information related to a business meeting;

FIG. 3 is a block diagram showing the configuration of a user terminal according to another exemplary embodiment;

FIG. 4 shows an example in which a user terminal displays different types of information related to situations which correspond to pre-set conditions, according to pre-defined relationships between the user and other users possessing other user terminals located within a predetermined distance or range from the user terminal;

FIG. 5 is a block diagram showing the configuration of a server according to an exemplary embodiment;

FIG. 6 is a block diagram showing the configuration of a situation-based information providing system according to an exemplary embodiment and

FIGS. 7 through 13 are flowcharts showing a situation-based information providing method according to an exemplary embodiment.

### DETAILED DESCRIPTION OF THE EXEMPLARY EMBODIMENTS

Certain exemplary embodiments will now be described in greater detail with reference to the accompanying drawings.

In the following description, same drawing reference numerals are used for the same elements even in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail since they would obscure the exemplary embodiments with unnecessary detail.

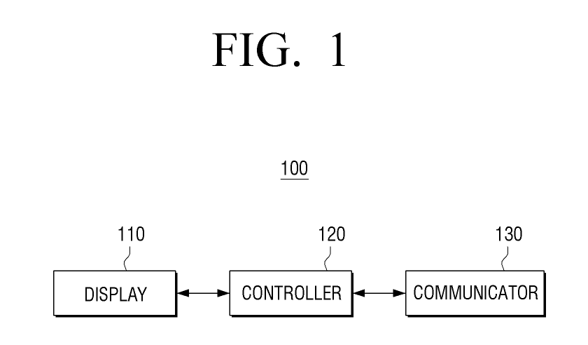

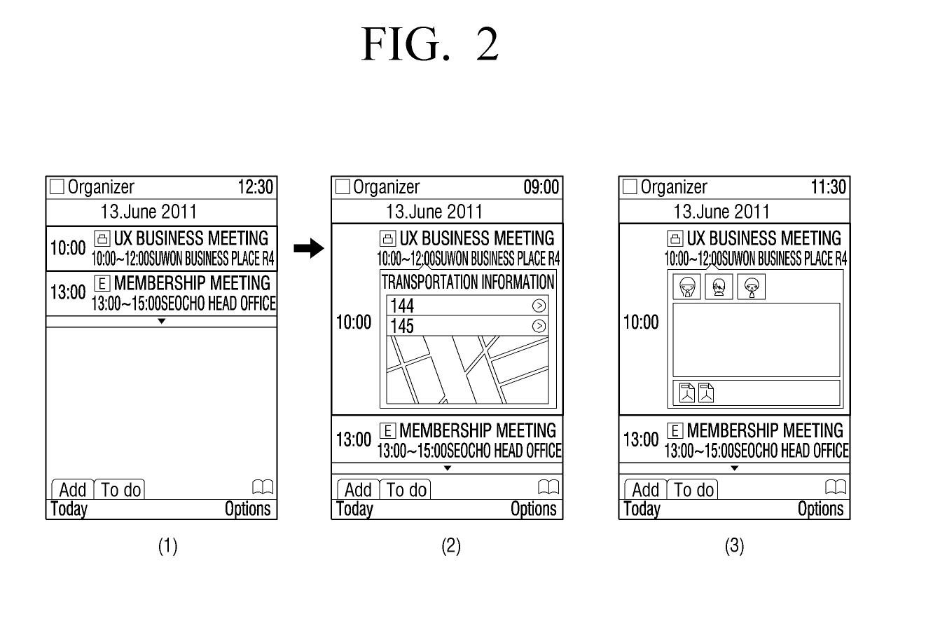

FIG. 1 is a block diagram showing the configuration of a user terminal 100 according to an exemplary embodiment and FIG. 2 shows an example in which the user terminal 100 of FIG. 1 displays information related to a business meeting.

Referring to FIGS. 1 and 2, the user terminal 100 includes a display 110, a communicator 130, and a controller 120.

The display 110 is used to display various kinds of information on a screen such that a user of the user terminal 100 can visually recognize the information. In response to the user terminal 100 being a smart device, the display 110 may include a liquid crystal display and a driving circuit thereof. However, the configuration of the display 110 is not limited thereto. Since the detailed configuration of the display 110 is irrelevant to the technical features of the present invention, a detailed description thereof will be omitted. The display 110 displays information related to a situation which corresponds to pre-set conditions in response to time information, location information of the user terminal 100, and another user's identification information satisfying the pre-set conditions, which will be described in more detail, later.

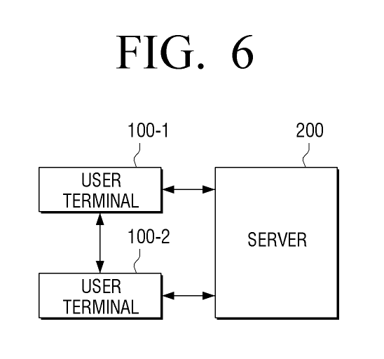

The communicator 130 is used to perform communication with other user terminals. The communication may be far field communication (FFC) or near field communication (NFC). In the former case, the user terminal 100 communicates with another user terminal 100-1 (see FIG. 6) located away from the user terminal 100 through a server 200 (see FIG. 6). In the latter case, the user terminal 100 may directly communicate with another user terminal 100-1 through Bluetooth. In response to the communicator 130 being a Bluetooth communication module, the user terminal 100 communicates with another user terminal 100-1 according to a Bluetooth communication standard to receive and transmit transmission packets. However, the user terminal 100 may use another NFC method, such as Zigbee, etc.

The communicator 130 includes a transmitter which transmits information, and a receiver which receives information. According to an exemplary embodiment, the receiver may receive terminal identification information from another user terminal 100-1 located within a predetermined distance or range from the user terminal 100.

The predetermined distance or range may be set by a user, by a service provider, or by a manufacturer of the user terminal 100. For example, the predetermined distance or range may be set to a 5-meter radius from the user terminal 100, or to the coverage range of a repeater located closest to the user terminal 100. That is, the predetermined distance or range may be set depending on the purpose and kind of service. The predetermined distance or range may be set depending on the user's situation. For example, in response to the user possessing the user terminal 100 having been scheduled to participate in a UX business meeting, a relatively wide distance or range may be set in consideration of the area of a conference room in which the UX business meeting will be held. In contrast, when the user of the user terminal 100 is scheduled to meet a friend, a relatively narrow distance or range may be set.

The terminal identification information is used to identify the other user terminal 100-1, and for example, the terminal identification information may include the serial number, phone number, user ID, etc. of the other user terminal 100-1. Terminal identification information received by the user terminal 100 is used only for the purpose of protection of personal information, and may not be stored in the user terminal 100.

The controller 120 is used to control the entire operation of the user terminal 100. When the controller 120 receives terminal identification information from the other user terminal 100-1, the controller 120 may control the display 110 to display information related to pre-set conditions in response to the received terminal identification information of the user terminal 100-1, time information, and location information of the user terminal 100 satisfying the pre-set conditions.

The time information represents information regarding a time at which situation-based information has been provided, is being provided, or will be provided. For example, in response to the user being scheduled to participate in a UX business meeting at a specific time, time information may be information regarding a time at which the user terminal 100 displays information related to the UX business meeting on the display 110, that is, a time at which the UX business meeting is held in the real world. As shown in FIG. 2, in response to a UX business meeting starting at 10:00 AM on 13 Jun. 2011, time information is 10:00 AM on 13 Jun. 2011. When the time arrives (that is, when a pre-set condition is satisfied), the controller 120 controls the display 110 to display information (information related to a situation which corresponds to the pre-set condition) related to the UX business meeting.

The location information of the user terminal 100 represents information about a location at which the user terminal 100 is present, i.e., information relating to a real-world location at which the user possessing the user terminal 100 is present. In particular, the location information of the user terminal 100 may be represented as a specific address or as a place located at a specific address.

The location information of the user terminal 100 may be acquired by transmitting location information determined by a Global Positioning System (GPS) method, a cell method, and an NFC method through an FFC network or an NFC network. The GPS method is a technology of acquiring the location of the user terminal 100 using a satellite (not shown), and can accurately detect a location over a relatively wide range. However, the GPS method cannot conduct more accurate location detection such as determination on whether a user is located inside or outside a building, etc. In this case, the cell method of detecting the location of the user terminal 100 through a repeater (not shown) is complementarily used. In order to acquire an accurate location of the user terminal 100, various location determination technologies need to be used together. For example, in response to a user being located at a conference room on the 8^{th} floor of a building A located in front of Seoul National University of Education of Korea, the GPS method may be used to determine that the user is located in the building A, and the cell method is used to determine that the user is located in the conference room on the 8^{th} floor. For more accurate location determination, the NFC method may be used. However, various location determination technologies other than the above-mentioned technologies may be additionally used.

The information related to the situation which corresponds to the pre-set conditions represents information needed in a situation that the user of the user terminal 100 experiences. According to the above-described embodiment, in response to there being a person who will participate in a UX business meeting within a predetermined distance or range, the user terminal 100 is located at the conference room on the 8^{th} floor of the building A located in front of Seoul National University of Education of Korea, and a time 10:00 AM on 13 Jun. 2011 arrives, the user of the user terminal 100 comes to be in a situation that corresponds to pre-set conditions of the UX business meeting. In this case, the controller 120 displays the display 110 to display information needed for the UX business meeting, for example, information relating to participants of the UX business meeting, presentation document, related memos, video, etc. on a screen (see (3) of FIG. 2). However different conditions may be set depending on exemplary embodiments. If a pre-set condition is set to 10:00 AM on 13 Jun. 2011, information relating to a place at which the UX business meeting will be held and information relating to transportation to arrive at the place may be displayed before 10:00 AM on 13 Jun. 2011 arrives since the UX business meeting is considered to have not yet started. Also, in response to there being no person who will participate in the UX business meeting within the predetermined distance or range when the time 10:00 AM on 13 Jun. 2011 arrives, the user terminal 100 may display different information irrelevant to the UX business meeting since the UX business meeting is considered to have been cancelled.

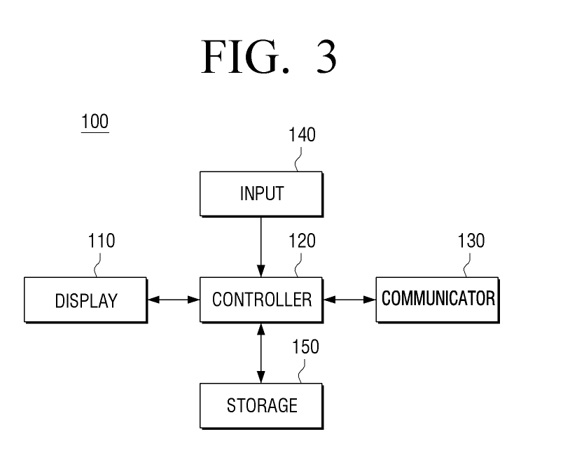

FIG. 3 is a block diagram showing the configuration of the user terminal 100 according to another exemplary embodiment.

Referring to FIG. 3, the user terminal 100 may further include an input 140 which receives inputs from a user.

The input 140 may be a keypad, a pen mouse, a touch screen or a touch pen. The pre-set condition as described above may be set by a user's input. That is, the user may input a condition which corresponds to a situation through the input 140 so that the display 110 can display information related to the situation. According to the above-described exemplary embodiment, the user may set conditions which correspond to a UX business meeting, that is, information (terminal identification information of persons who will participate in the UX business meeting) relating to persons who will participate in the UX business meeting, information (for example, a conference room on the 8^{th} floor of a building A located in front of Seoul National University of Education of Korea) about a place at which the UX business meeting will be held, and information (for example, 10:00 AM on 13 Jun. 2011) about a time at which the UX business meeting will be held. In response to received terminal identification information of another user terminal 100-1, time information, and location information of the user terminal 100 being identical to the conditions set by the user, the user terminal 100 displays information related to the conditions. In the above-described exemplary embodiment, information needed for the UX business meeting is displayed on the screen.

Also, as shown in FIG. 3, the user terminal 100 may further include a storage 150.

The storage 150 may store all kinds of data required to provide situation-based information. For example, if the user terminal 100 receives terminal identification information of another user terminal 100-1 which is located within a predetermined distance or range from the user terminal 100, the user terminal 100 needs to check whether the received terminal identification information is identical to terminal identification information of a user terminal of a person who will participate in the UX business meeting. At this time, the controller 120 reads terminal identification information of user terminals of persons who will participate in the UX business meeting from the storage 150, and compares the read terminal identification information to the received terminal identification information, thereby determining whether a pre-set condition is satisfied. Also, the storage 150 may store information relating to the relationship between the user of the user terminal 100 and the user of the other user terminal 100-1 located within a predetermined distance or range from the user terminal 100. In response to the received terminal identification information being in the storage 150, the controller 120 may read information relating to the relationship between the user of the user terminal 100 and the user of the other user terminal 100-1 from the storage 150 and control the display 110 to display information related to a situation which corresponds to a pre-set condition according to the relationship between the user of the user terminal 100 and the user of the other user terminal 100-1. The relationship between the user of the user terminal 100 and the user of the other user terminal 100-1, and the operation of the controller 120 according to the relationship will be described in more detail later.

In response to received identification information of the other user terminal 100-1, time information, and location information of the user terminal 100 satisfying pre-set conditions, the user terminal 100 may control the display 110 to display an application related to a situation which corresponds to the pre-set conditions. That is, in the above-described exemplary embodiment, the user terminal 100 may display an application needed for a UX business meeting, in addition to information related to the UX business meeting. For example, an application for recording a UX business meeting on tape or videotape when the application is executed, an application for executing a laser pointer function when the user terminal 100 includes a configuration capable of emitting a laser beam, an application for checking mails, etc., may be displayed. Also, the user terminal 100 may display information relating to participants of the UX business meeting, presentation documents, related memos, videos, etc. in such a manner to conveniently check documents, etc. by directly connecting them to their related applications. Preferably, the applications may be displayed as icons on a part of a screen so that each application can be executed by one click or one touch (in the case of a touch screen).

The controller 120 may control the display 110 to display information or applications related to a situation which corresponds to pre-set conditions in consideration of one of a keyword input by the user content being used by the user, and log history.

First, the controller 120 may control the display 110 to display information or applications related to a situation which corresponds to pre-set conditions in consideration of a keyword included in text input by a user. The user may input text information relating to a situation that the user experiences, through the input 140, other than pre-set conditions. In this case, the controller 120 may parse the text input by the user to extract words included in the text, and may compare the extracted words to a pre-stored keyword. In response to a determination that the pre-stored keyword is included in the text, the controller 120 controls the display 110 to display information or an application related to a situation which corresponds to the pre-set conditions in consideration of the corresponding keyword. For example, in the above-described embodiment related to the UX business meeting, the user may input a schedule title “User Experience at Business Meeting” through the input 140. The controller 120 parses the text, and extracts a keyword. If a pre-stored keyword is User Experience, the controller 120 displays information or applications that have been often used in business meetings or conferences according to the user's experience. Meanwhile, in response to a pre-stored keyword being Business Meeting, the controller 120 may display information or applications that are used in general business meetings. However, the above-described embodiments are only exemplary, and information or applications which correspond to a keyword may depend on an implementation policy of the exemplary embodiments.

Second, the controller 120 may control the display 110 to display information or applications related to a situation which corresponds to pre-set conditions in consideration of content being used by a user. For example, in response to a user using a patent document, the controller 120 may display a patent search application, an application of searching for laid-open documents from the patent offices of various countries, and documents relating to patent law and regulation of various countries or other areas of law.

Third, the controller 120 may control the display 110 to display information or an application related to a situation which corresponds to pre-set conditions in consideration of log history. The log history means document access history or execution history of applications that have been executed in the user terminal 100. The controller 120 may control the display 110 to display applications or documents that have been executed after or accessed in a situation satisfying pre-set conditions.

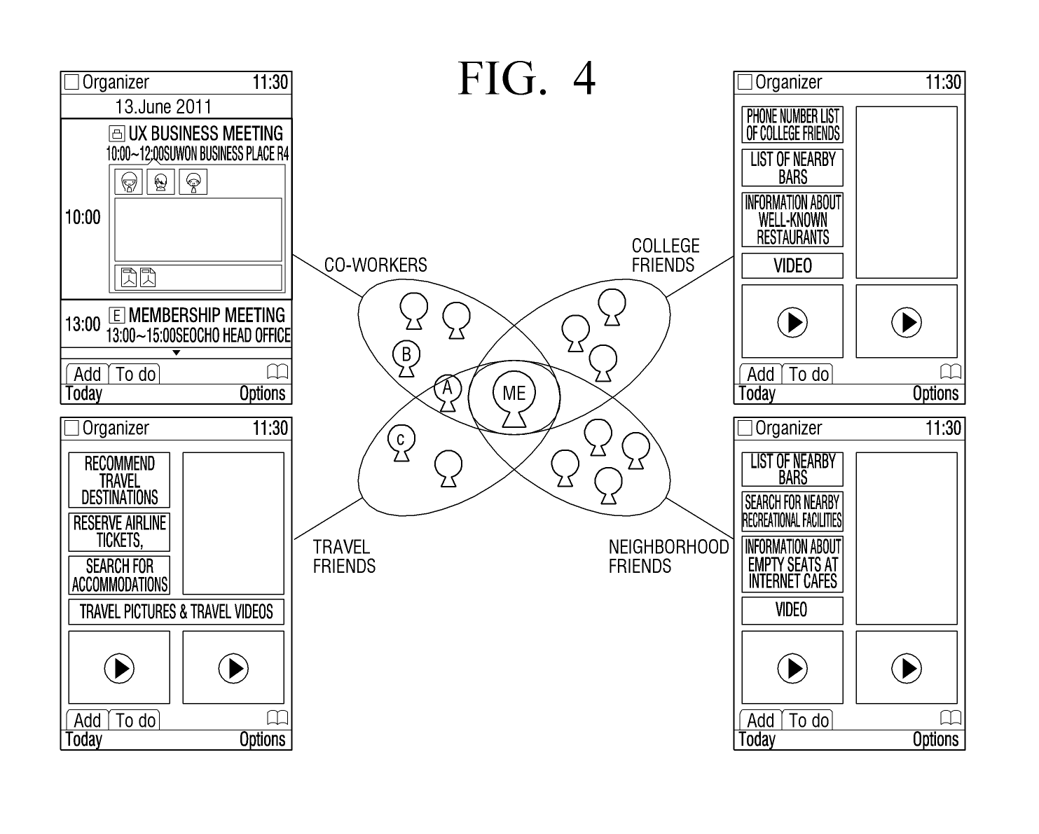

FIG. 4 shows an example in which the user terminal 100 (see FIG. 3) displays different types of information related to situations which correspond to pre-set conditions, according to pre-defined relationships between the user and other users possessing other user terminals 100-1 (see FIG. 6) located within a predetermined distance or range from the user terminal 100.

Referring to FIGS. 3, 4, and 6, in response to received terminal identification information of another user terminal 100-1 being located within a predetermined distance or range from the user terminal 100, time information, and location information of the user terminal 100 satisfy pre-set conditions, the controller 120 may control the display 110 to display information or applications related to a situation which corresponds to the pre-set conditions according to the pre-defined relationship between the user of the user terminal 100 and the user of the other user terminal 100-1.

A pre-defined relationship between the users of user terminals means connection attributes that have been socially defined between the users. For example, as shown in FIG. 4, the user of the user terminal 100 and the user of the other user terminal 100-1 may be in a co-worker relationship, in a travel friend relationship, in a college friend relationship, or in a neighborhood friend relationship. The controller 120 identifies the user of the other user terminal 100-1 through received identification information of the other user terminal 100-1, and interprets the relationship between the user of the user terminal 100 and the user of the other user terminal 100-1. In the above-described exemplary embodiment related to the UX business meeting, in response to the controller 120 identifying a person who will participate in the UX business meeting based on terminal identification information of the other user terminal 100-1 located within the predetermined distance or range from the user terminal 100, the user terminal 100 is located at the conference room on the 8^{th} floor of the building A located in front of Seoul National University of Education of Korea, at which the UX business meeting has been scheduled to be held. At a time at which the UX business meeting will be held is 10:00 AM on 13 Jun. 2011, the controller 120 displays the display 110 to display information or applications related to the UX business meeting situation in response to the user of the user terminal 100 and the user of the other user terminal 100-1 being determined to be in a co-worker relationship. The pre-defined relationship between the user of the user terminal 100 and the user of the other user terminal 100-1 may be recognized when the other user is identified through the terminal identification information of the other user terminal 100-1.

Meanwhile, the pre-defined relationships between users possessing terminals may be received from a server connected to the user terminal 100 through a wired or wireless communication device, instead of being stored within the storage 150 of the user terminal 100, and may be determined by reading of the controller 120. In this case, the communicator 130 may transmit terminal identification information of the user terminal 100 and terminal identification information of the other user terminal 100-1 to the server 200, and may receive information regarding a pre-defined relationship between the user of the user terminal 100 and the user of the other user terminal 100-1 from the server 200. The server 200 may be a social network service (SNS) server providing an SNS, a mail server, a cloud server, etc.

For example, in response to the server 200 being an SNS server, the user terminal 100 transmits terminal identification information of the user terminal 100 and terminal identification information of the other user terminal 100-1 to the SNS server 200. Then, the SNS server 200 searches for a parameter indicating a social relationship between the user of the user terminal 100 and the user of the other user terminal 100-1 and set in the SNS server 200 based on the terminal identification information of the user terminal 100 and the terminal identification information of the other user terminal 100-1, and transmits the found parameter to the user terminal 100. The user terminal 100 receives the relationship parameter, and displays information or an application related to a situation which corresponds to pre-set conditions. In the above-described example related to the UX business meeting, only when the user of the user terminal 100 and the user of the other user terminal 100-1 are co-workers or belong to the same business team or business group, are information or applications related to the UX business meeting displayed.

Meanwhile, as shown in FIG. 4, in response to the user of the user terminal 100 and the user of the other user terminal 100-1 are in the college friend relation, and the user terminals 100 and 100-1 are located within a predetermined distance or range, information or applications related to a college friend meeting situation are displayed in consideration of time information and location information of the user terminal 100. For example, a phone number list of college friends, a list of nearby bars, information about well-known restaurants, stored wedding video of college friends, etc. may be displayed.

Also, in response to the user of the user terminal 100 and the user of the other user terminal 100-1 being in the travel friend relationship, and the user terminals 100 and 100-1 are located within a predetermined distance or range, information or applications related to a travel friend meeting situation are displayed in consideration of time information and location information of the user terminal 100. For example, an application which recommends travel destinations, an application which reserves airline tickets, an application which searches for accommodations, travel pictures or travel video, etc. may be displayed.

Also, as shown in FIG. 4, in response to the user of the user terminal 100 and the user of the other user terminal 100-1 being in the neighborhood friend relationship, and the user terminals 100 and 100-1 are located within a predetermined distance or range, information or applications related to a neighborhood friend meeting situation are displayed in consideration of time information and the location information of the user terminal 100. For example, a list of nearby bars, an application for searching for nearby recreational facilities, information about empty seats at Internet cafes, pictures, etc. may be displayed.

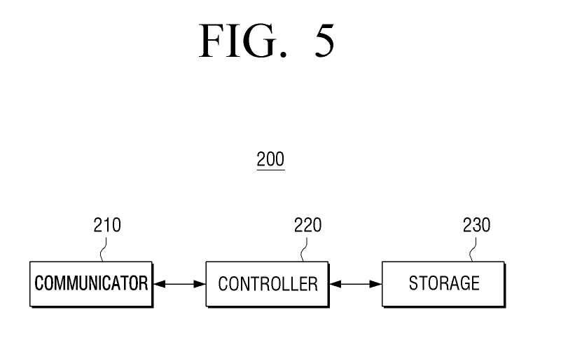

Hereinafter, the server 200 providing situation-based information according to an exemplary embodiment will be described. FIG. 5 is a block diagram showing the configuration of the server 200.

Referring to FIG. 5, the server 200 includes a communicator 210, a controller 220, and a storage 230.

The communicator 210 is used to communicate with a user terminal 100 (see FIG. 1 or 3). In particular, the communicator 210 receives terminal identification information of the user terminal 100 and terminal identification information of another user terminal 100-1 (see FIG. 6) from the user terminal 100, and transmits to the user terminal 100 information relating to a pre-defined relationship between the user of the user terminal 100 and the user of the other user terminal 100-1. Here, the server 200 may be an SNS server, a mail server, a cloud server, etc.

In response to the server 200 being an SNS server, the user terminal 100 transmits terminal identification information of the user terminal 100 and terminal identification information of the other user terminal 100-1 to the SNS server 200. The SNS server 200 searches for a parameter which indicates a social relationship between the user of the user terminal 100 and the user of the other user terminal 100-1 and set in the SNS server 200 based on the terminal identification information of the user terminal 100 and the terminal identification information of the other user terminal 100-1, and transmits the found parameter to the user terminal 100

The storage 230 stores data required to operate the server 200. Particularly, the storage 230 may store the relationships between the users of a plurality of user terminals (100 for each).

For example, in response to the user terminal 100 receiving terminal identification information of another user terminal 100-1 located within a predetermined distance or range from the user terminal 100, the user terminal 100 needs to check whether the received terminal identification information is identical to terminal identification information of a user terminal of a person who will participate in a UX business meeting. At this time, the user terminal 100 transmits the terminal identification information of the other user terminal 100-1 to the server 200. The controller 220 of the server 200 reads from the storage 230 terminal identification information of user terminals of persons who will participate in the UX business meeting, compares the read terminal identification information to the received terminal identification information, and transmits the results of the comparison to the user terminal 100.

Also, the storage 230 may store information about the relationship between the user of the user terminal 100 and the user of the other user terminal 100-1 located within the predetermined distance or range from the user terminal 100.

The controller 220 controls the entire operation of the server 200. In detail, in response to the controller 220 receiving terminal identification information of the other user terminal 100-1 located within a predetermined distance or range from the user terminal 100, the controller 220 reads a pre-defined relationship between the user of the user terminal 100 and the user of the other user terminal 100-1 from the storage 230, and controls the communicator 210 to transmit information regarding the pre-defined relationship to the user terminal 100. In the exemplary embodiment related to the UX business meeting, in response to a determination by controller 220 that the user of the user terminal 100 and the user of the other user terminal 100-1 are in a co-worker relationship, based on the terminal identification information of the user terminals 100 and 100-1, stored in the storage 230, the controller 220 controls the communicator 210 to transmit a parameter indicating the co-worker relationship to the user terminal 100.

Hereinafter, a situation-based information providing system according to an exemplary embodiment will be described. FIG. 6 is a block diagram showing the configuration of the situation-based information providing system.

Referring to FIG. 6, the situation-based information providing system includes the server 200 and the user terminals 100 and 100-1 (see FIGS. 1, 3, and 5).

The server 200 receives from the user terminal 100 terminal identification information of the other terminal 100-1 located within a predetermined distance or range from the user terminal 100 and transmits information regarding a pre-defined relationship between the user of the user terminal 100 and the user of the other user terminal 100-1 to the user terminal 100. Details for the operation of the server 200 have been described above, and accordingly, a repeated description will be omitted.

The user terminal 100 displays information related to a situation, according to the information regarding the pre-defined relationship between the user of the user terminal 100 and the user of the other user terminal 100-1, received from the server 200, time information, and location information of the user terminal 100. Details for the operation of the user terminal 100 have been described above, and accordingly, a repeated description will be omitted.

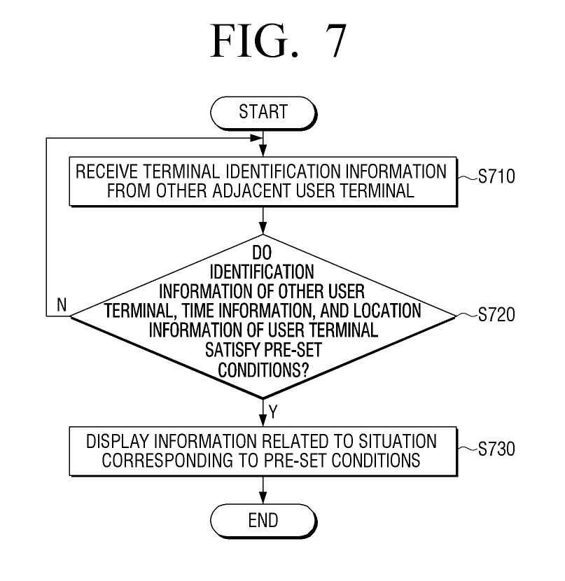

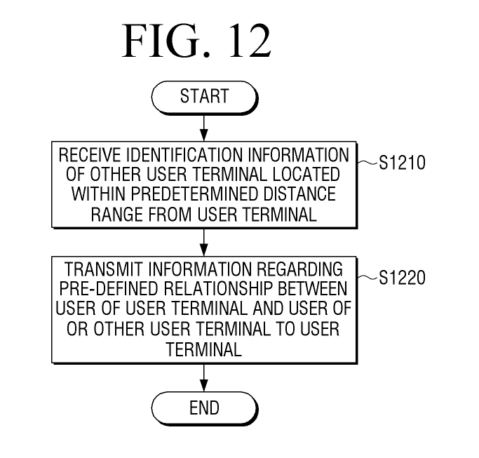

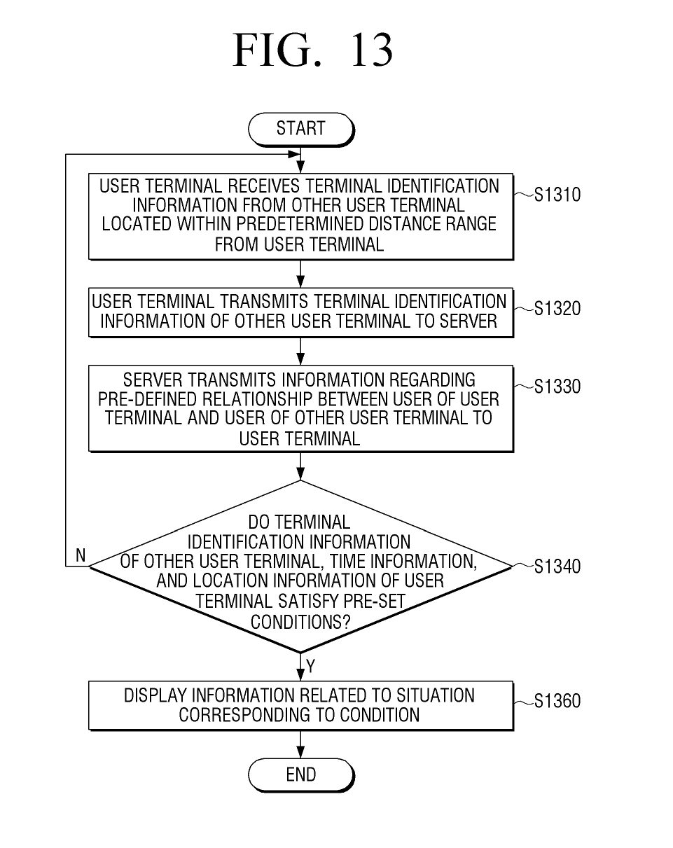

Hereinafter, a situation-based information providing method according to an exemplary embodiment will be described. FIGS. 7 through 13 are flowcharts showing the method of providing situation-based information.

Referring to FIGS. 7 through 13, the method of providing situation-based information includes: receiving terminal identification information of another user terminal located within a predetermined distance or range from a user terminal (S710); determining whether the terminal identification information of the other user terminal, time information, and location information of the user terminal satisfy pre-set conditions (S720); and displaying, in response to the terminal identification information of the other user terminal, the time information, and the location information of the user terminal satisfying the pre-set conditions (S720—Y), information related to a situation which corresponds to the pre-set conditions (S730).

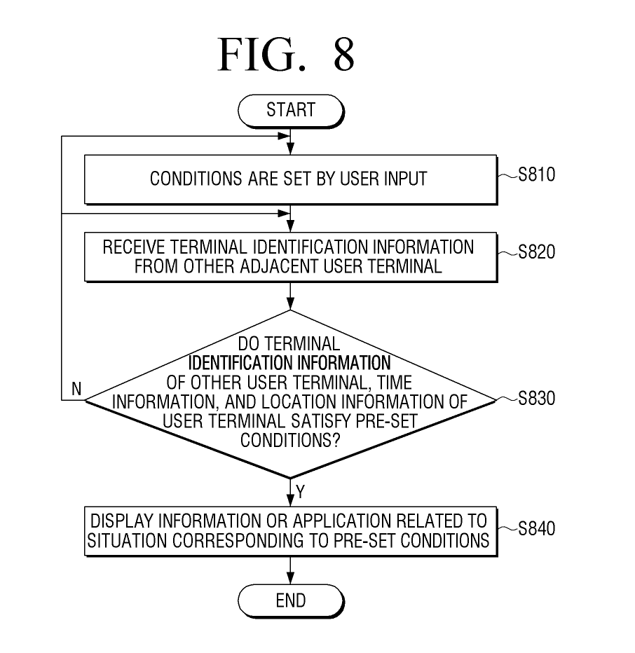

The pre-set conditions may be set by a user's input (S810). That is, as shown in FIG. 8, in response to pre-set conditions being set by the user's input (S810), terminal identification information is received from another user terminal located adjacent to the user terminal (S820), and the terminal identification information of the other user terminal, time information, and location information of the user terminal satisfy the pre-set conditions (S830—Y), information related to a situation which corresponds to the pre-set conditions is displayed (S840).

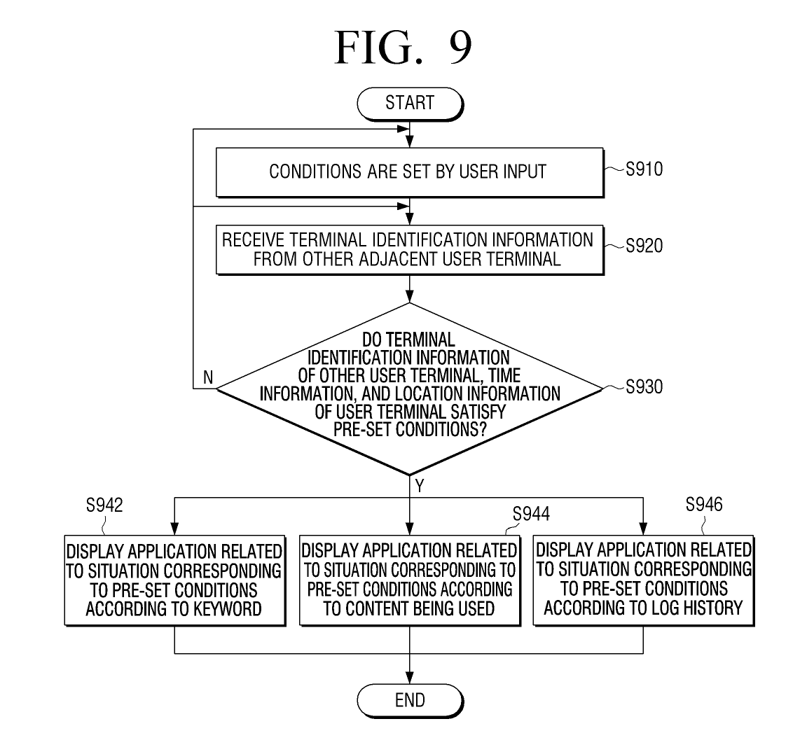

Also, as shown in FIG. 9, in operation of displaying the information related to the situation which corresponds to the pre-set conditions, in response to the terminal identification information of the other user terminal, the time information, and the location information of the user terminal satisfying the pre-set conditions (S930—Y), an application may be displayed in consideration of one of a keyword input by the user content being used by the user, and log history (S942, S944, and S946).

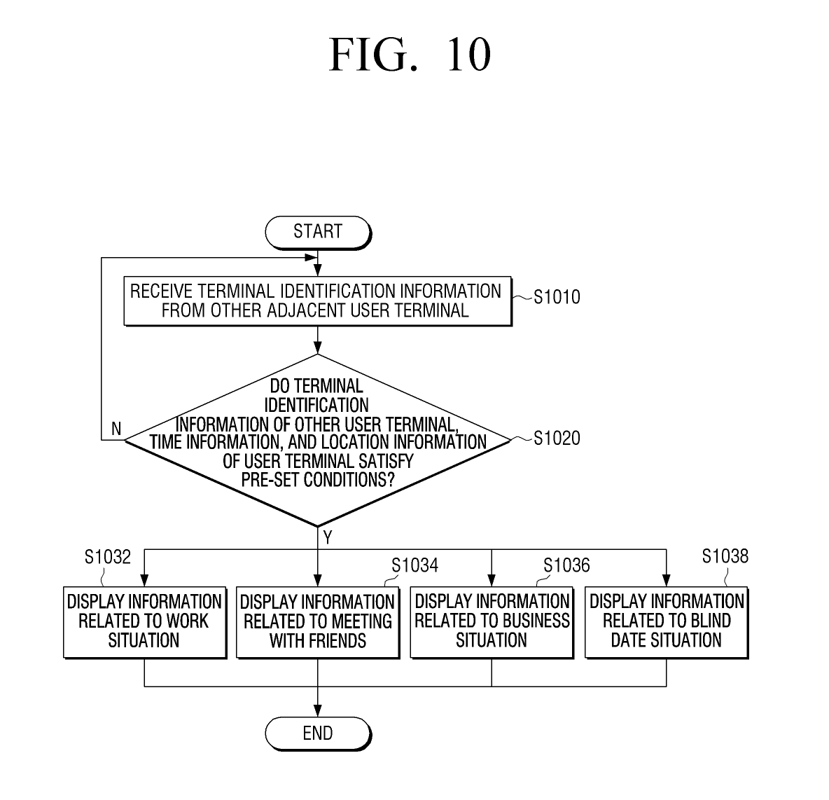

Also, as shown in FIG. 10, in operation of displaying the information related to the situation which corresponds to the pre-set conditions, information related to a situation which corresponds to the pre-set conditions may be displayed according to a pre-defined relationship between the user of the user terminal and the user of the other user terminal. That is, information related to a situation which corresponds to pre-set conditions according to a co-worker relationship, a friend relationship, a business relationship, or a romantic relationship may be displayed (S1032, S1034, S1036, or S1038).

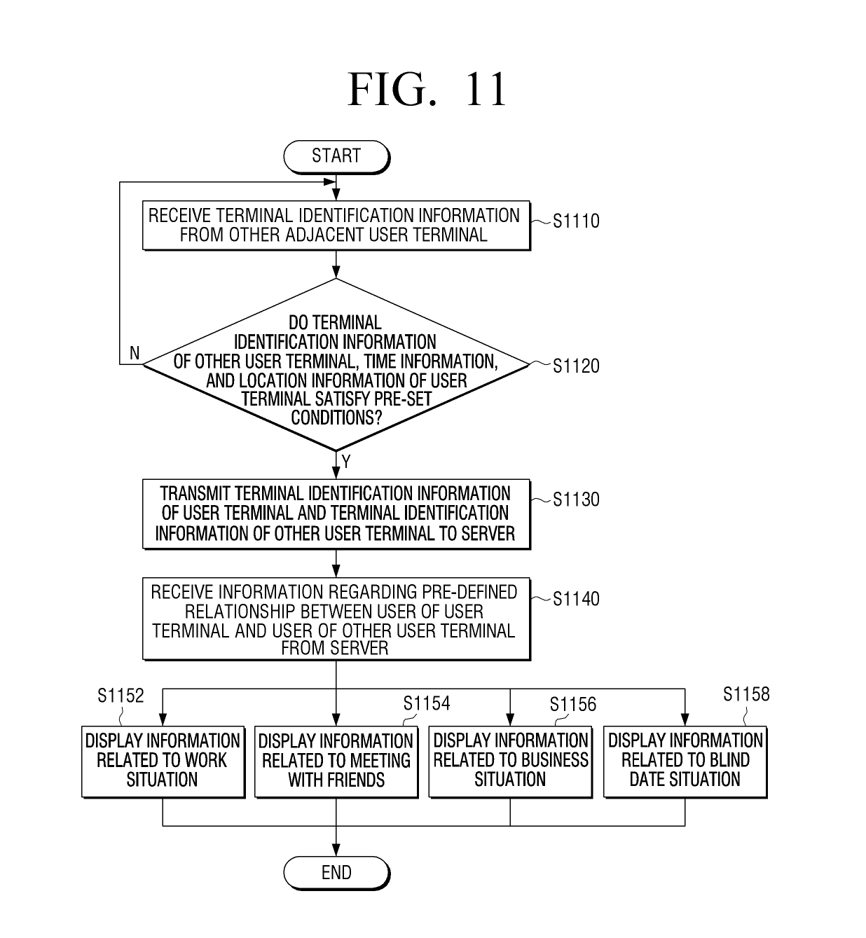

In particular, in an operation of displaying the information related to the situation which corresponds to the pre-set conditions, as shown in FIG. 11, the terminal identification information of the user terminal and the terminal identification information of the other user terminal may be transmitted to a server (S1130), information regarding a pre-defined relationship between the user of the user terminal and the user of the other user terminal may be received from the server (S1140), and information related to a situation which corresponds to pre-set conditions according to the pre-defined relationship between the user of the user terminal and the user of the other user terminal may be displayed (S1152, S1154, S1156, or S1158). Here, the server may be an SNS server, a mail server or a cloud server.

The situation-based information providing method may include: receiving terminal identification information of another user terminal located within a predetermined distance or range from a user terminal (S1210); and transmitting information regarding a pre-defined relationship between the user of the user terminal and the user of the other user terminal to the user terminal (S1220).

Also, the situation-based information providing method may include: receiving, at a user terminal, terminal identification information of another user terminal located within a predetermined distance or range from the user terminal (S1310); transmitting, at the user terminal, terminal identification information of the user terminal and terminal identification information of the other user terminal to a server (S1320); transmitting, at the server, information regarding a pre-defined relationship between the user of the user terminal and the user of the other user terminal to the user terminal (S1330); determining whether the terminal identification information of the other user terminal, time information, and location information of the user terminal satisfy pre-set conditions (S1340); and displaying, in response to the terminal identification information of the other user terminal, the time information, and the location information of the user terminal satisfying the pre-set conditions (S1340—Y), information related to a situation which corresponds to the pre-set conditions according to the information regarding the pre-defined relationship between the user of the user terminal and the user of the other user terminal (S1360).

As described above, information related to a situation that a user possessing a user terminal experiences is provided according to a social relationship with another person located adjacent to the user and location information of the user. Accordingly, the user receives information about a person who he or she meets and information about a place at which he or she is located, through his or her terminal.

The user terminal may include a display and a controller that controls the display to display information related to a situation which corresponds to pre-set conditions in response to time information and location information of the user terminal satisfying the pre-set conditions. That is, as described above, the user terminal may display information related to a situation only in consideration of time information and location information of the user terminal, without considering terminal identification information received from another user terminal located within a predetermined distance or range from the user terminal.

The individual components of the user terminal are the same as those of the user terminal 100 as described above, except that the relationship with another user terminal is not considered. Accordingly, detailed descriptions for the individual components will be omitted, and an exemplary embodiment will be briefly described.

According to the above-described exemplary embodiment related to the UX business meeting, when conditions related to the UX business meeting have been set in advance, in response to a user terminal being located at a conference room on the 8^{th} floor of a building A located in front of Seoul National University of Education of Korea (a specific location), and 10:00 AM on 13 Jun. 2011 comes (a specific time), the user of the user terminal comes to be in a UX business meeting situation (a situation which corresponds to the pre-set conditions). In this case, the controller controls a display to display information needed for the UX business meeting, for example, information relating to participants of the UX business meeting, presentation documents, related memos, videos, etc. on a screen. Also, related applications, etc. may be displayed. That is, applications needed for the UX business meeting, in addition to information related to the UX business meeting situation, may be displayed. For example, an application for recording a UX business meeting on tape or videotape when the application is executed, an application for executing a laser pointer function when the user terminal includes a configuration capable of emitting a laser beam, an application for checking mails, etc., may be displayed. Also, the user terminal may display information relating to participants of the UX business meeting, presentation documents, related memos, videos, etc. in such a manner so as to conveniently check documents, etc. by directly connecting them to their related applications. Preferably, the applications may be displayed as icons on a part of a screen so that each application can be executed by one click or one touch (in the case of a touch screen)

In response to a pre-set condition being set to 10:00 AM on 13 Jun. 2011, information relating to a place at which the UX business meeting will be held, information relating to transportation to arrive at the place, geographical information indicating the place, and information related to issues of the UX business meeting may be displayed before 10:00 AM on 13 Jun. 2011 arrives since the UX business meeting is considered to have not yet started. Also, in response to the user terminal being out of the specific location when the time 10:00 AM on 13 Jun. 2011 arrives, the user terminal may display different information irrelevant to the UX business meeting since the UX business meeting is considered to have been cancelled. However, the user terminal may display information related to the UX business meeting by determining that the user has forgotten about the UX business meeting.

Also, according to another exemplary embodiment, a method of providing situation-based information of displaying information or applications related to a user's situation through the user's terminal may be provided. The method is the same as the method of providing situation-based information as described above, except that a relationship with another user terminal is not considered, and accordingly, a detailed description thereof will be omitted.

The foregoing exemplary embodiments and advantages and description are merely exemplary and are not to be construed as limiting the present invention. The present teaching can be readily applied to other types of apparatuses and systems. Also, the description of the exemplary embodiments is intended to be illustrative, and not to limit the scope of the claims, and many alternatives, modifications, and variations will be apparent to those skilled in the art.

What is claimed is:

1. A user terminal comprising:
a communicator configured to communicate with another user terminal located within a predetermined distance or range from the user terminal; and
a controller configured to receive terminal identification information from the other user terminal, and to control, in response to the received terminal identification information of the other user terminal, time information, and location information of the user terminal satisfying pre-set conditions, and to control a display to display information related to a situation which corresponds to the pre-set conditions.

2. The user terminal of claim 1, further comprising an input configured to receive a user's input, wherein the pre-set conditions are set by the user's input.

3. The user terminal of claim 1, wherein in response to the terminal identification information of the user terminal, the time information, and the location information of the user terminal satisfying the pre-set conditions, the controller controls the display to display an application related to the situation which corresponds to the pre-set conditions.

4. The user terminal of claim 3, wherein the controller controls the display to display the application in consideration of one of a keyword input by the user, content being used by the user and log history.

5. The user terminal of claim 1, wherein the controller controls the display to display information related to the situation which corresponds to the pre-set conditions according to a pre-defined relationship between the user of the user terminal and the user of the other user terminal.

6. The user terminal of claim 5, wherein the pre-defined relationship is at least one of a co-worker relationship, a friend relationship, a business relationship and a romantic relationship.

7. The user terminal of claim 5, wherein the communicator transmits the terminal identification information of the user terminal and the terminal identification information of the other user terminal, to the server, and receives from the server information regarding the pre-defined relationship between the user of the user terminal and the user of the other user terminal.

8. The user terminal of claim 7, wherein the server is at least one of a social network service (SNS) server providing an SNS, a mail server and a cloud server.

9. A server comprising:
a communicator configured to communicate with a user terminal;
a storage configured to store a pre-defined relationship between users of a plurality of user terminals; and
a controller configured to read, in response to receiving terminal identification information of another user terminal located within a predetermined distance or range from a user terminal of the plurality of user terminals from the user terminal, information regarding a pre-defined relationship between the user of the user terminal and the user of the other user terminal from the storage, and to control the communicator to transmit to the user terminal the information regarding the pre-defined relationship.

10. A situation-based information providing system comprising:
a server configured to receive from a user terminal identification information of another user terminal located within a predetermined distance or range from a user terminal, and to transmit to the user terminal information regarding a pre-defined relationship between the user of the user terminal and the user of the other user terminal; and
the user terminal configured to display information related to a situation according to the information regarding the pre-defined relationship between the user of the user terminal and the user of the other user terminal, time information and location information of the user terminal.

11. A method of providing situation-based information, the method comprising:
receiving, at a user terminal, terminal identification information from another user terminal located within a predetermined distance or range from the user terminal; and
displaying, at the user terminal, information related to a situation which corresponds to pre-set conditions in response to the terminal identification information of the other user terminal, time information, and location information of the user terminal satisfying the pre-set conditions.

12. The situation-based information providing method of claim 11, wherein the pre-set conditions are set by the user's input.

13. The method of providing situation-based information of claim 11, wherein the displaying of the information related to the situation which corresponds to the pre-set conditions comprises displaying an application related to the situation which corresponds to the pre-set conditions in response to the terminal identification information of the other user terminal, the time information, and the location information of the user terminal satisfying the pre-set conditions.

14. The method of providing situation-based information of claim 13, wherein the displaying of the information related to the situation which corresponds to the pre-set conditions comprises displaying the application in consideration of one of a keyword input by the user content being used by the user, and log history.

15. The method of providing situation-based information of claim 11, wherein the displaying of the information related to the situation which corresponds to the pre-set conditions comprises displaying information related to the situation which corresponds to the pre-set conditions according to a pre-defined relationship between the user of the user terminal and the user of the other user terminal.

16. The method of providing situation-based information of claim 15, wherein the pre-defined relationship is at least one of a co-worker relationship, a friend relationship, a business relationship and a romantic relationship.

17. The method of providing situation-based information of claim 15, wherein the displaying of the information related to the situation which corresponds to the pre-set conditions comprises:
transmitting to the server the terminal identification information of the user terminal and the terminal identification information of the other user terminal; and
receiving from the server information regarding a pre-defined relationship between the user of the user terminal and the user of the other user terminal and displaying the information related to the situation which corresponds to the pre-set conditions according to the pre-defined relationship between the user of the user terminal and the user of the other user terminal.

18. The method of providing situation-based information of claim 17, wherein the server is at least one of a social network service (SNS) server providing an SNS, a mail server and a cloud server.

19. A situation-based information providing method comprising:
receiving from a user terminal, at a server, terminal identification information of another user terminal located within a predetermined distance or range from a user terminal; and
transmitting to the user terminal, at the server, information regarding a pre-defined relationship between the user of the user terminal and the user of the other user terminal.

20. A situation-based information providing method, the method comprising:
receiving, at a user terminal, terminal identification information of another user terminal located within a predetermined distance or range from the user terminal;
transmitting, at the user terminal, terminal identification information of the user terminal and terminal identification information of the other user terminal to a server;
transmitting, at the server, information regarding a pre-defined relationship between the user of the user terminal and the user of the other user terminal to the user terminal; and
displaying, at the user terminal, information related to a situation which corresponds to pre-set conditions according to the information regarding the pre-defined relationship between the user of the user terminal and the user of the other user terminal in response to the terminal identification information of the other user terminal, time information, and location information of the user terminal satisfying the pre-set conditions.
